(19) United States
(12) Patent Application Publication
(10) Pub. No.: US 2016/0031056 A1
(43) Pub. Date: Feb. 4, 2016

(54) Method of fault detection and classification (FDC) for improved tool control capabilities

(71) Applicant: UNITED MICROELECTRONICS CORP., Hsin-Chu City (TW)

(72) Inventors: Feng-Chi Chung, Hsinchu County (TW); Ching-Hsing Hsieh, Hsinchu County (TW); Chen-Hui Huang, Hsinchu City (TW); Hsin-Kun Chu, Kaohsiung City (TW)

(21) Appl. No.: 14/451,406

(22) Filed: Aug. 4, 2014

(51) Int. Cl. B23Q 15/28

(52) U.S. Cl. CPC B23Q 15/28

(57) ABSTRACT

A method of a fault detection and classification (FDC) may be used to determine outlier tools from a plurality of tools. The method includes generating a plurality of parameter charts, generating a plurality of group charts according to the plurality of parameter charts, generating a score table according to the plurality of group charts, determining outlier tools according to the score table, and performing tool correction on the outlier tools.

### BACKGROUND OF THE INVENTION

1. Field of the Invention

The present invention discloses a method of fault detection and classification (FDC), and more particularly a method of fault detection and classification (FDC) for improved tool control capabilities.

2. Description of the Prior Art

Recent advances in advanced process control (APC) in the area of semiconductor processing equipment (SPE), or tools, used by semiconductor manufacturing facilities (fabs) in the production of high performance integrated circuits, include the addition of monitoring hardware and software at the tool level (TL) that is used for the purpose of fault detection and classification (FDC).

The use of feed-forward controllers in semiconductor processing has long been established practice by fabs in the manufacture of semiconductor integrated circuits. Recent advances in APC used by fabs in the production of high performance integrated circuits include the addition of hardware and software at the tool level that is used for the purpose of run-to-run (R2R) control.

However, the run-to-run (R2R) control uses data from past process runs to adjust settings for the next run and reduce the variability during each run. The run-to-run (R2R) control does not take into account the disparity in the performance of the same tools for each run.

### SUMMARY OF THE INVENTION

An embodiment of the present invention presents a method of a fault detection and classification (FDC). The method of a fault detection and classification (FDC) comprises generating a plurality of parameter charts, generating a plurality of group charts, generating a score table according to the plurality of group charts, determining outlier tools according to the score table, and performing tool correction on the outlier tools. Each parameter chart corresponds to one measured parameter of one tool of a plurality of tools. Each group chart is generated according to parameter charts of the plurality of parameter charts corresponding to one same measured parameter of the plurality of tools.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a method of a fault detection and classification (FDC) according to an embodiment of the present invention.

FIG. 2 illustrates the plurality of parameter charts in FIG. 1.

FIG. 3 illustrates group charts according to the plurality of parameter charts in FIG. 2.

FIG. 4 illustrates a score table according the group charts in FIG. 3.

FIG. 5 illustrates a chart of the other plurality of groups according to the score table in FIG. 4.

### DETAILED DESCRIPTION

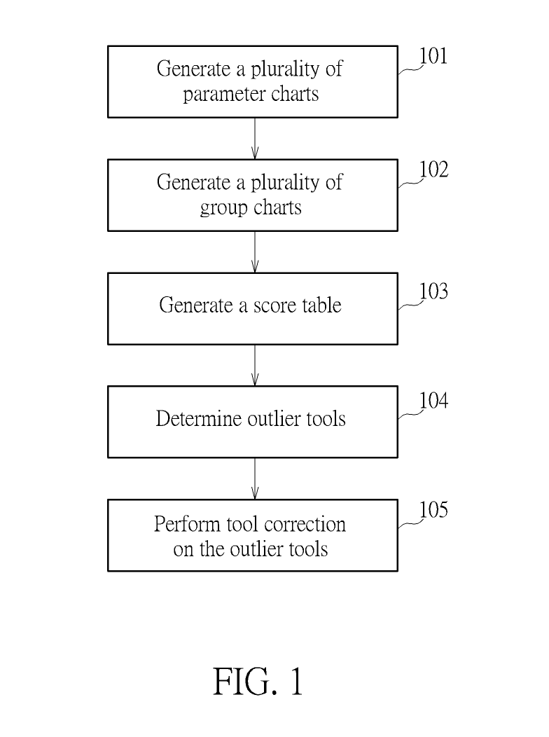

FIG. 1 illustrates a flowchart of a method of a fault detection and classification (FDC) according to an embodiment of the present invention. The method may include but is not limited to the following steps:

Step 101: generate a plurality of parameter charts (C₁₋₁-C_{N-M}), each parameter chart (C₁₋₁-C_{N-M}) corresponds to one measured parameter of one tool of a plurality of a same kind of tools;

Step 102: generate a plurality of group charts, each group chart is generated according to parameter charts of the plurality of parameter charts (C₁₋₁-C_{N-M}) corresponding to one same measured parameter of the plurality of tools;

Step 103: generate a score table according to the plurality of group charts (GC₁-GC_{M});

Step 104: determine outlier tools according to the score table;

Step 105: perform tool correction on the outlier tools.

For the purpose of clarity, a hot plate is used throughout the description as an example of a tool of which the fault detection and classification (FDC) is performed on. The fault detection and classification (FDC) may be performed on N tools with each tool having M parameters. For example, there may be N hot plates and each hot plate may have M parameters. The parameters of the hot plate may, for example, include a rise time, a fall time, and a temperature consistency.

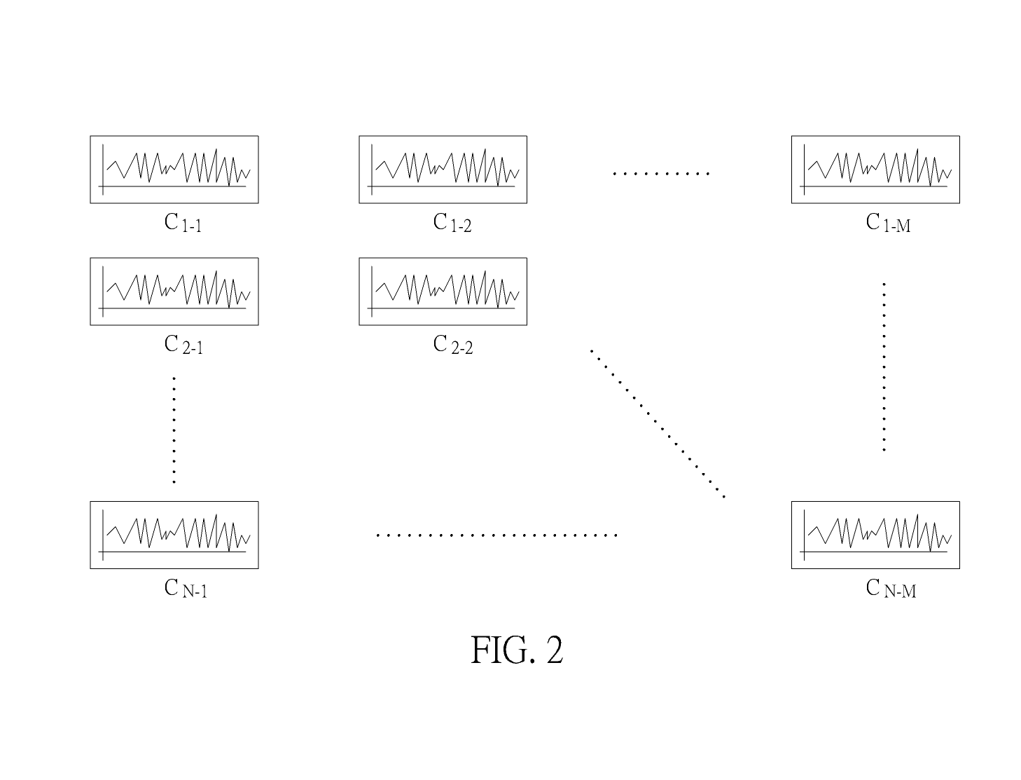

In step 101, the plurality of parameter charts are generated. FIG. 2 illustrates the plurality of parameter charts (C₁₋₁-C_{N-M}) in FIG. 1. Each of the plurality of parameter charts (C₁₋₁-C_{N-M}) corresponds to one measured parameter of one tool of the plurality of tools. Application servers (AP servers) may be used for the collection of data used in generating the plurality of charts. For example, if there are 5 hot plates being monitored and each hot plate has 5 parameters, a total of 25 parameter charts are to be generated. Each hot plate has 5 corresponding parameter charts. The 5 parameters may be the same 5 parameters for each hot plate. A parameter chart maybe generated by observing a parameter such as temperature, voltage, or current corresponding to the tool during an operation. Therefore, in some embodiments, the parameter chart may be dependent on time. An example of a parameter chart may be taking the temperature reading of a hot plate during a time period of operation where the hot plate is required to output a consistent temperature.

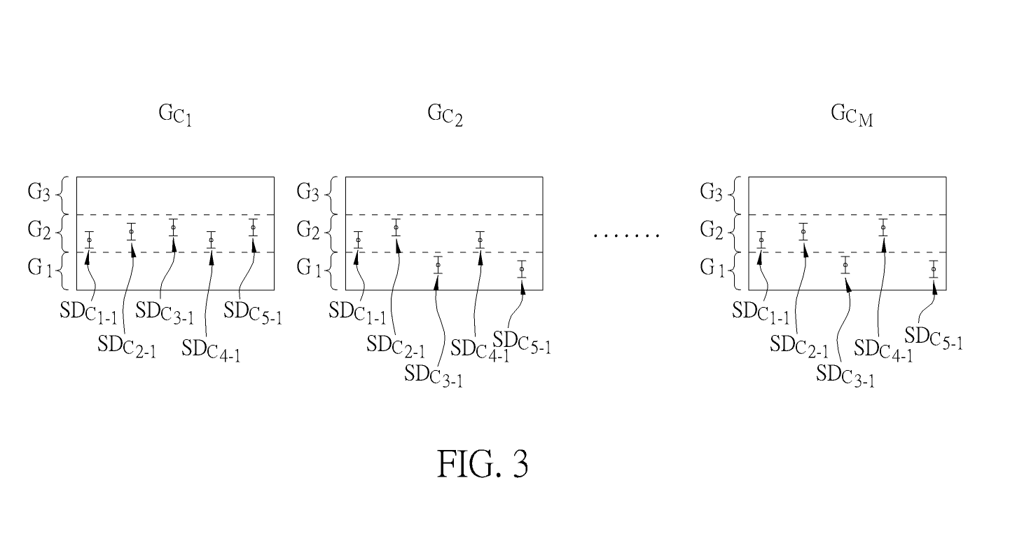

In step 102, the plurality of group charts are generated. Each of the plurality of group charts may correspond to one measured parameter of the plurality of tools. A standard deviation (SD_{C1-1}-SD_{CN-M}) of each of the plurality of parameter charts (C₁₋₁-C_{N-M}) may be determined. A plurality of groups is set according to the standard deviation (SD_{C1-1}-SD_{CN-M}) of each of the plurality of parameter charts (C₁₋₁-C_{N-M}). And, each of the plurality of tools is grouped into the plurality of groups according corresponding respective standard deviation (SD_{C1-1}-SD_{CN-M}) of the tools. FIG. 3 illustrates group charts (GC₁-GC_{M}) according to the plurality of parameter charts (C₁₋₁-C_{N-M}) in FIG. 2.

Based on the determined standard deviations (SD_{C1-1}-SD_{CN-M}), the plurality of tools may be grouped into at least three groups. The groups may be a golden group G1, acceptable group G2, and an outlier group G3. The golden group G1 may include tools having a standard deviation value that is less than a first predetermined value. The acceptable group G2 may include tools having a standard deviation value that is greater than the first predetermined value but is less than or equal to a second predetermined value. And the outlier group may include tools having a standard deviation value that is greater than the second predetermined value.

The first predetermined value may be a sum of a lowest standard deviation from the plurality of standard deviations and a group sigma of the plurality of standard deviations. And the second predetermined value may be two group sigmas higher than the sum. Wherein group sigma may be calculated as the standard deviation of the standard deviations (SD_{C1-1}-SD_{CN-M}) plotted in a corresponding group chart (GC₁- GC_{M}).

To further understand, a standard deviation SD_{C1-1} of a first tool may be observed. If the value of the standard deviation SD_{C1-1} is less than or equal to the first predetermined value, the first tool may be grouped into the golden group G1. If the value of the standard deviation SD_{C1-1} is greater than the first predetermined value but less than or equal to the second predetermined value, the first tool may be grouped into the acceptable group G2. And, if the value of the standard deviation SD_{C1-1} is greater than the second predetermined value, the first tool may be grouped into the outlier group G3.

For example, according to the example in step 101, there may be 5 group charts generated for the hot plates since each hot plate has 5 parameters and each group chart may include 5 standard deviations to correspond to each of the 5 hot plates.

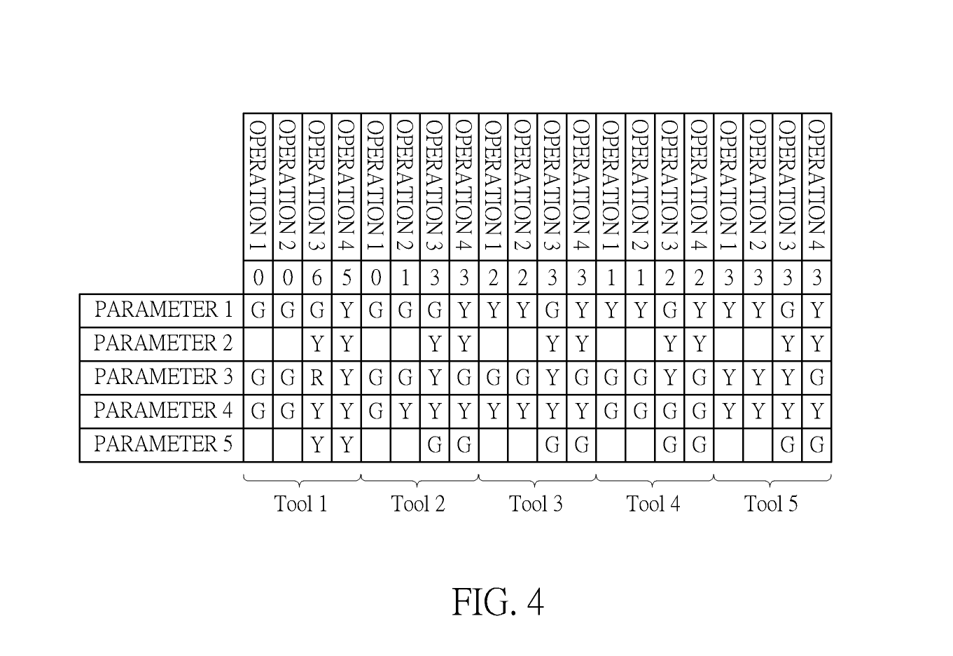

In step 103, the score table is generated according to the plurality of group charts. The score table may include a score of each parameter of each tool at each operation. Each of the score in the score table may correspond to the groupings of the tools in the group charts. FIG. 4 illustrates a score table according the group charts (GC₁-GC_{M}) in FIG. 3. As shown in FIG. 4, the first column of the chart identifies the parameters of each tool. The first row identifies the operation done by each tool. The second row may indicate the total score of the tool for each operation.

The score may be based on the groupings in the group charts in FIG. 3. For example, if a tool is in the golden group for a certain operation, it may be indicated in the score table as G. If a tool is in the acceptable group for a certain operation, it may be indicated in the score table as Y. And, if a tool is in the outlier group for a certain operation, it may be indicated in the score table as R. Each of the indicators G, Y, and R may have corresponding score. For example, G may correspond to a score of 0, Y may correspond to a score of 1, and R may correspond to a score of 3. Therefore, if all of the parameters of a tool in an operation fall into the golden group, the total score may be 0. If not all of the parameters of a tool in an operation fall into the golden group, the total score may be dependent on how many parameters of a tool in an operation fall into the acceptable group or the outlier group.

In step 104, outlier tools are determined according to the score table. To determine the outlier tools, tools from the plurality of tools having no parameter in an outlier group may be determined. A plurality of tool score sums may be determined. Each tool score sum may correspond to a tool of the plurality of tools other than the tools having no parameter in the outlier group. Each tool score sum may be sum of the total scores of the operations of the tool for which the sum is being calculated. For example, as shown in FIG. 4, the first tool (Tool 1) may have a tool score sum of 11, the second tool (Tool 2) may have a tool score sum of 7, the third tool (Tool 3) may have a tool score sum of 10, the fourth tool (Tool 4) may have a tool score sum of 6, and the fifth tool (Tool 5) may have a tool score sum of 12. Another plurality of groups may be set according to the plurality of tool score sums. An average of the plurality of tool score sums and another group sigma of the plurality of tool score sums may be determined. The plurality of tools other than the tools having no parameter in the outlier group are grouped into the other plurality of groups according to the plurality of tool score sums.

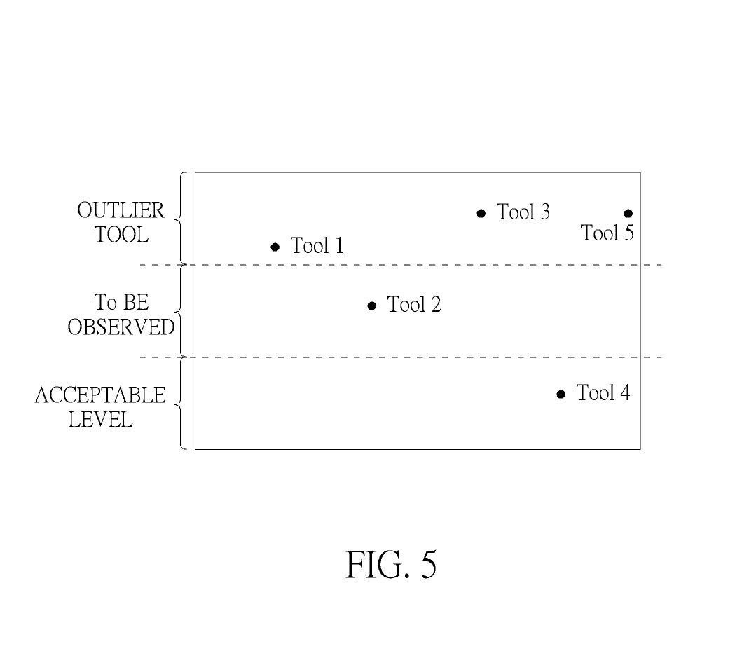

FIG. 5 illustrates a chart of the other plurality of groups according to the score table in FIG. 4. The other plurality of groups may include three groups. The first group may include tools operating in an acceptable level. The acceptable level may include tools having a tool score sum less than or equal to the average of all of the tool score sums divided by the group sigma of all of the tool score sums. The second group may include tools that need to be observed. The tools that need to be observed may include tools having a tool score sum between the other group sigma and the average divided by the other group sigma. The third group may include outlier tools. The outlier tools may include the remaining tools.

In step 105, tool correction is performed on the outlier tools. Tool correction is performed on the outlier tools by changing a recipe of the outlier tools.

After performing the tool correction, the fault detection and classification (FDC) maybe reset and step 101 maybe performed again. Each cycle of the fault detection and classification (FDC) may last for a predetermined period of time, i.e. 24 hours. The fault detection and classification (FDC) may be repeated until all of the plurality of tools are grouped in the golden group.

The use of the embodiment of the fault detection and classification (FDC) is not limited to being used to monitor a hot plate. The described fault detection and classification (FDC) may be used in monitoring any types of equipment used in a semiconductor fabrication process.

The present invention presents a fault detection and classification (FDC) that is used for tool-to-tool control. The fault detection and classification (FDC) is used to reduce the disparity between the plurality of tools during a semiconductor fabrication process and is a continuous improvement process. The fault detection and classification (FDC) uses a statistical process control (SPC) technique to determine the outlier tools. The statistical process control (SPC) technique includes computation of the group sigmas. The fault detection and classification (FDC) may also include a user interface that is used to display a report of the fault detection and classification (FDC) to the user. The report may include matching details of the plurality of tools. Due to the adjustments made to the outlier tools, the relative baseline for comparison for each cycle of the fault detection and classification (FDC) may vary. Also, since tool-to-tool control is used, tool correction may be performed in each run. Whereas, the prior art run-to-run control needs to perform comparison between runs before correction is made, therefore, the error correction may be performed at least after two runs.

Operation of an FDC system at the tool level has the advantages of decreasing production scrap due to tool level faults, decreasing tool downtime by improving diagnostic capability and decreasing the amount of unscheduled maintenance by monitoring parts wear and scheduling preventative maintenance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of a fault detection and classification (FDC), comprising:
generating a plurality of parameter charts, each parameter chart corresponding to one measured parameter of one tool of a plurality of tools;
generating a plurality of group charts, each group chart generated according to parameter charts of the plurality of parameter charts corresponding to one same measured parameter of the plurality of tools;
generating a score table according to the plurality of group charts;
determining outlier tools according to the score table; and
performing tool correction on the outlier tools.

2. The method of claim 1, wherein the fault detection and classification is used for tool-to-tool control.

3. The method of claim 1, wherein the plurality of tools are a same type of tools.

4. The method of claim 1, wherein generating a plurality of group charts comprises:
determining a plurality of standard deviations, each of the plurality of standard deviations uniquely corresponding to one of the plurality of parameter charts;
setting a plurality of groups according to the plurality of standard deviations; and
grouping the plurality of tools into the plurality of groups according to the plurality of standard deviations.

5. The method of claim 4, wherein the plurality of groups comprise a golden group having a value less than or equal to a first predetermined value, an acceptable group having a value greater than the first predetermined value but is less than or equal to a second predetermined value, and an outlier group having a value greater than the second predetermined value.

6. The method of claim 5, wherein the first predetermined value is a sum of a lowest standard deviation from the plurality of standard deviations and a group sigma of the plurality of standard deviations, and the second predetermined value is two group sigmas higher than the sum.

7. The method of claim 4, wherein determining the outlier tools according to the score table comprises:
determining tools from the plurality of tools having no parameter in an outlier group;
determining a plurality of tool score sums, each of the plurality of tool score sums corresponds to a tool score sum of each of the plurality of tools other than the tools having no parameter in the outlier group;
setting another plurality of groups according to the plurality of tool score sums; and
grouping the plurality of tools other than the tools having no parameter in the outlier group into the other plurality of groups according to the plurality of tool score sums;
wherein the plurality of tool score sums are a sum of corresponding scores of each of the plurality of tools in the score table.

8. The method of claim 7, wherein determining the outlier tools according to the score table further comprises:
determining an average of the plurality of tool score sums and another group sigma of the plurality of tool score sums;
wherein tools having a tool score sum less than or equal to the average divided by the other group sigma are operating in an acceptable level; tools having a tool score sum between the other group sigma and the average divided by the other group sigma are to be observed; and remaining tools are the outlier tools.

9. The method of claim 1, wherein determining the outlier tools according to the score table comprises:
determining tools from the plurality of tools having no parameter in an outlier group;
determining a plurality of tool score sums, each of the plurality of tool score sums corresponds to a tool score sum of each of the plurality of tools other than the tools having no parameter in the outlier group;
setting another plurality of groups according to the plurality of tool score sums; and
grouping the plurality of tools other than the tools having no parameter in the outlier group into the other plurality of groups according to the plurality of tool score sums;
wherein the plurality of tool score sums are a sum of corresponding scores of each of the plurality of tools in the score table.

10. The method of claim 9, wherein determining the outlier tools according to the score table further comprises:
determining an average of the plurality of tool score sums and another group sigma of the plurality of tool score sums;
wherein tools having a tool score sum less than or equal to the average divided by the other group sigma are operating in an acceptable level; tools having a tool score sum between the other group sigma and the average divided by the other group sigma are to be observed; and remaining tools are the outlier tools.

11. The method of claim 1, wherein performing tool correction on the outlier tools is performing tool correction on the outlier tools by changing a recipe of the outlier tools.

12. The method of claim 1, wherein the fault detection and classification (FDC) resets after a predetermined period of time.

13. The method of claim 1, wherein a statistical process control (SPC) technique is used in determining the outlier tools.
